(19) United States
(12) Patent Application Publication
(10) Pub. No.: US 2024/0264300 A1
(43) Pub. Date: Aug. 8, 2024

(54) STATE ESTIMATION OF A TARGET USING SENSOR MEASUREMENTS

(71) Applicant: Arriver Software AB, Novi, MI (US)

(72) Inventor: Bernard DE MERSSEMAN, Andover, MA (US)

(21) Appl. No.: 18/158,267

(22) Filed: Jan. 23, 2023

(51) Int. Cl. G01S 13/58; G01S 13/86

(52) U.S. Cl. CPC G01S 13/589; G01S 13/865

(57) ABSTRACT

In some aspects, a computing device may determine, via one or more sensors of the computing device, sensor measurements associated with a target, wherein the sensor measurements include a relative radial acceleration. The computing device may determine a measurement model based at least in part on the sensor measurements associated with the target including the relative radial acceleration. The computing device may provide the measurement model to a second order Kalman filter. The computing device may determine, based at least in part on the second order Kalman filter, a state estimate of the target. The computing device may provide a command based at least in part on the state estimate of the target. Numerous other aspects are described.

### FIELD OF THE DISCLOSURE

Aspects of the present disclosure generally relate to sensors and, for example, to state estimation of a target using sensor measurements.

### BACKGROUND

Sensor fusion and system state estimation may involve combining sensor data from multiple sensors to produce more reliable information with less uncertainty, as compared to when the sources are used individually. Direct fusion may involve the fusion of sensor data from a set of heterogeneous or homogeneous sensors, while indirect fusion may use information sources such as a priori knowledge about the environment and human input. Sensor fusion and system state estimation may be achieved using a Kalman filter, which is a prediction-correction filtering technique, as well as by using other approaches.

### SUMMARY

In some implementations, an apparatus includes one or more sensors; a memory; and one or more processors, coupled to the memory, configured to: determine, via the one or more sensors, sensor measurements associated with a target, wherein the sensor measurements include a relative radial acceleration aᵣ(k); determine a measurement model based at least in part on the sensor measurements associated with the target including the relative radial acceleration aᵣ (k); provide the measurement model to a second order Kalman filter; determine, based at least in part on the second order Kalman filter, a state estimate of the target; and provide a command based at least in part on the state estimate of the target.

In some implementations, a method performed by a computing device includes determining, via one or more sensors of the computing device, sensor measurements associated with a target, wherein the sensor measurements include a relative radial acceleration aᵣ(k)e; determining a measurement model based at least in part on the sensor measurements associated with the target including the relative radial acceleration aᵣ(k); providing the measurement model to a second order Kalman filter; determining, based at least in part on the second order Kalman filter, a state estimate of the target; and providing a command based at least in part on the state estimate of the target.

In some implementations, a non-transitory computer-readable medium storing a set of instructions includes one or more instructions that, when executed by one or more processors of a computing device, cause the computing device to: determine, via one or more sensors of the computing device, sensor measurements associated with a target, wherein the sensor measurements include a relative radial acceleration aᵣ(k) determine a measurement model based at least in part on the sensor measurements associated with the target including the relative radial acceleration aᵣ(k); provide the measurement model to a second order Kalman filter; determine, based at least in part on the second order Kalman filter, a state estimate of the target; and provide a command based at least in part on the state estimate of the target.

In some implementations, an apparatus includes means for determining, via one or more sensors of the apparatus, sensor measurements associated with a target, wherein the sensor measurements include a relative radial acceleration aᵣ(k); means for determining a measurement model based at least in part on the sensor measurements associated with the target including the relative radial acceleration aᵣ(k); means for providing the measurement model to a second order Kalman filter; means for determining, based at least in part on the second order Kalman filter, a state estimate of the target; and means for providing a command based at least in part on the state estimate of the target.

Aspects generally include a method, apparatus, system, computer program product, non-transitory computer-readable medium, user device, user equipment, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which systems and/or methods described herein may be implemented.

FIG. 2 is a diagram illustrating example components of a device, in accordance with the present disclosure.

FIG. 3 is a diagram illustrating an example of radial measurements, in accordance with the present disclosure.

FIG. 4 is a diagram illustrating an example associated with a state estimation of a target using sensor measurements, in accordance with the present disclosure.

FIG. 5 is a diagram illustrating an example associated with a radial acceleration vector, in accordance with the present disclosure.

FIG. 6 is a diagram illustrating an example associated with a radial velocity vector, in accordance with the present disclosure.

FIG. 7 is a diagram illustrating an example associated with a yaw angle and yaw rate estimation, in accordance with the present disclosure.

FIG. 8 is a diagram illustrating an example associated with a calculation of a measurement covariance matrix, in accordance with the present disclosure.

FIG. 9 is a flowchart of an example process associated with a state estimation of a target using sensor measurements, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A sensor, such as a radar sensor or a light detection and ranging (LIDAR) sensor, may sense in a radial manner. The sensor may determine a radial range, a radial velocity, and/or a radial acceleration. However, trajectory, tracking, and localization may take place using a Cartesian referential. The sensor may measure an azimuth angle θ, but the sensor may be unable to measure directly on a frame-by-frame basis an angular rate \dot{θ}. In other words, the sensor may measure radial position and motion, while an environment perception model may use the Cartesian referential. State variables of the environment perception model may be defined in a Cartesian coordinate system, while a measurement vector may be radial. A radial versus Cartesian error over one 50 ms cycle time may be relatively small when a target is at a significant range (e.g., greater than 30 meters) or when the directions of travel are not very different (e.g., nearly parallel, which would result in a relatively low angular rate). The radial versus Cartesian error may become significant at close proximity (e.g., less than 30 meters) or when the directions of travel are considerably different (e.g., a crossing path or during a sudden acceleration). Existing solutions may rely on a motion model and a Kalman filter technique. However, such existing solutions may rely on motion models that introduce errors due to non-linearities and due to assumptions for the sake of simplification.

In some implementations, a computing device may determine, via one or more sensors associated with the computing device, sensor measurements associated with a target. The computing device may be associated with a first vehicle. The target may be associated with a second vehicle. The sensor measurements may include a relative radial acceleration. The relative radial acceleration may be based at least in part on a Doppler chirp rate at a time instance. The computing device may determine a measurement model (or measurement vector) based at least in part on the sensor measurements associated with the target including the relative radial acceleration. The computing device may provide the measurement model to a second order Kalman filter. The computing device may determine, based at least in part on the second order Kalman filter, a state estimate of the target. The state estimate of the target may be a filtered estimation of a state vector. The computing device may provide a command based at least in part on the state estimate of the target. For example, the command may be associated with accelerating the first vehicle, braking the first vehicle, and/or turning the first vehicle.

In some aspects, a second order Kalman filter with a non-conventional measurement vector may be used, where the measurement vector may be compatible with radar and coherent homodyne LIDAR or a prior fusion of measurements. The measurement vector may utilize the Doppler chirp rate to improve an accuracy of an acceleration state estimation. Further, by using the measurement vector, the computing device may be able to obtain a more accurate environment perception model, which may be used to more accurately determine the state estimate of the target.

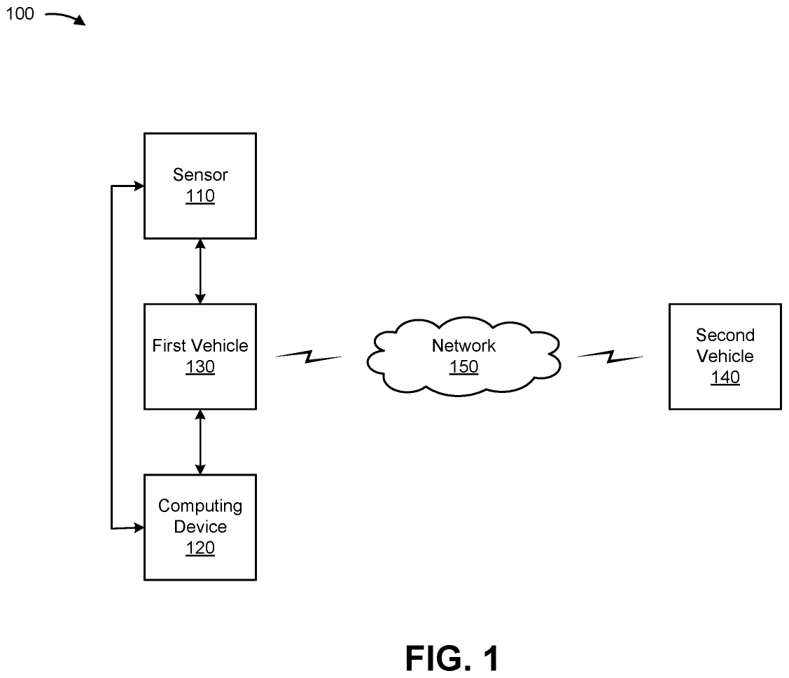

FIG. 1 is a diagram of an example environment 100 in which systems and/or methods described herein may be implemented. As shown in FIG. 1, environment 100 may include a sensor 110, a computing device 120, a first vehicle 130, a second vehicle 140, and a network 150. The second vehicle 140 may be associated with a target. Devices of environment 100 may interconnect via wired connections, wireless connections, or a combination of wired and wireless connections.

The sensor 110 may include a radar sensor and/or a LIDAR sensor. The sensor 110 may be configured to capture various measurements, such as radial range, azimuth, relative radial velocity, and/or relative radial acceleration. The sensor 110 may provide the measurements to the computing device 120. The computing device 120 may determine a state estimate of the target based at least in part on the measurements. The computing device 120 may employ a Kalman filter (or an extended Kalman filter), which may be used to determine the state estimate of the target based at least in part on the measurements. The sensor 110 and the computing device 120 may be associated with the first vehicle 130. For example, the sensor 110 and the computing device 120 may be onboard the first vehicle 130. The second vehicle 140 may be moving relative to the first vehicle 130. For example, the second vehicle 140 may be moving at a certain velocity and/or a certain acceleration.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

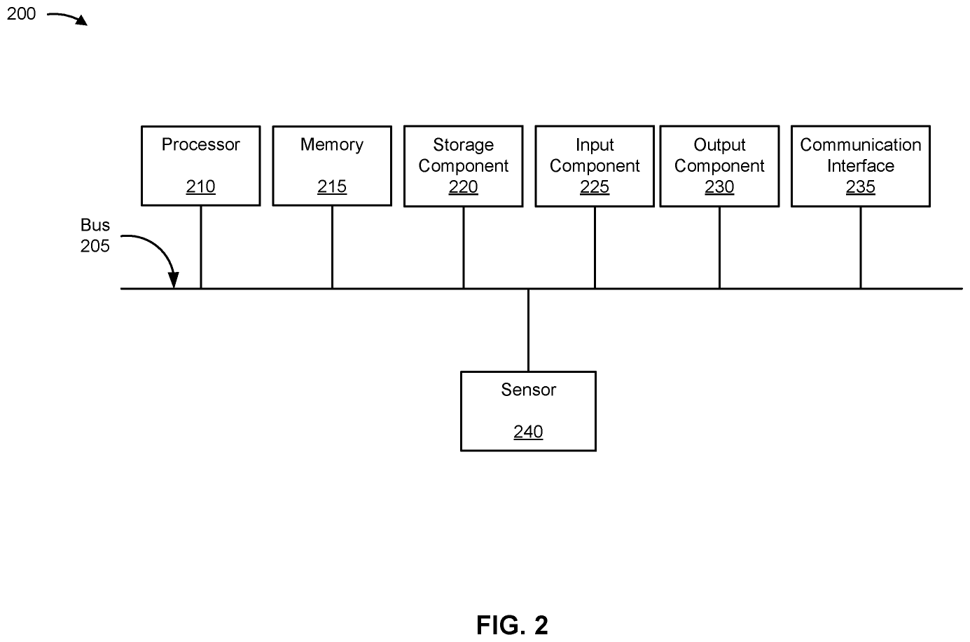

FIG. 2 is a diagram illustrating example components of a device 200, in accordance with the present disclosure. Device 200 may correspond to computing device 120. In some aspects, computing device 120 may include one or more devices 200 and/or one or more components of device 200. As shown in FIG. 2, device 200 may include a bus 205, a processor 210, a memory 215, a storage component 220, an input component 225, an output component 230, a communication interface 235, and/or a sensor 240 (or multiple sensors). The sensor 240 may be a radar sensor or a LIDAR sensor.

Bus 205 includes a component that permits communication among the components of device 200. Processor 210 is implemented in hardware, firmware, or a combination of hardware and software. Processor 210 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 includes one or more processors capable of being programmed to perform a function. Memory 215 includes a random access memory (RAM), a read only memory (ROM), and/or another type of dynamic or static storage device (e.g., a flash memory, a magnetic memory, and/or an optical memory) that stores information and/or instructions for use by processor 210.

Storage component 220 stores information and/or software related to the operation and use of device 200. For example, storage component 220 may include a solid state memory device, a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 includes a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 includes a component that provides output information from device 200 (e.g., a display, a speaker, a haptic feedback component, and/or an audio or visual indicator).

Communication interface 235 includes a transceiver-like component (e.g., a transceiver and/or a separate receiver and transmitter) that enables device 200 to communicate with other devices, such as via a wired connection, a wireless connection, or a combination of wired and wireless connections. Communication interface 235 may permit device 200 to receive information from another device and/or provide information to another device. For example, communication interface 235 may include an Ethernet interface, an optical interface, a coaxial interface, an infrared interface, a radio frequency interface, a universal serial bus (USB) interface, a wireless local area interface (e.g., a Wi-Fi interface), and/or a cellular network interface.

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication interface 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, device 200 includes means for performing one or more processes described herein and/or means for performing one or more operations of the processes described herein. For example, device 200 may include means for determining, via one or more sensors of the computing device, sensor measurements associated with a target, wherein the sensor measurements include a relative radial acceleration \ddot{r}ₖ; means for determining a measurement model based at least in part on the sensor measurements associated with the target including the relative radial acceleration \ddot{r}ₖ; means for providing the measurement model to a second order Kalman filter; means for determining, based at least in part on the second order Kalman filter, a state estimate of the target, and/or means for providing a command based at least in part on the state estimate of the target. In some aspects, such means may include one or more components of device 200 described in connection with FIG. 2, such as bus 205, processor 210, memory 215, storage component 220, input component 225, output component 230, communication interface 235, and/or sensor 240.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

A sensor, such as a radar sensor or a LIDAR sensor, may sense in a radial manner. The sensor may determine a radial range, a radial velocity, and/or a radial acceleration. However, trajectory, tracking, and localization may take place using a Cartesian referential. The sensor may measure an azimuth angle θ, but the sensor may be unable to measure directly on a frame-by-frame basis an angular rate \dot{θ}. A radial versus Cartesian error over one 50 ms cycle time may be relatively small when a target is at a significant range (e.g., greater than 30 meters) or when the directions of travel are not very different (e.g., nearly parallel, which would result in a relatively low angular rate). The radial versus Cartesian error may become significant at close proximity (e.g., less than 30 meters) or when the directions of travel are considerably different (e.g., a crossing path, during a sudden acceleration, or during a sudden change of direction). The directions of travel may be considerably different due to a maneuver through a roundabout, due to an intersection, or due to urban clutter. A relative velocity measurement by a Doppler frequency measurement may be radial. A rate of Doppler change, which also may be referred to as a Doppler chirp rate, (df_{doppler}/dt), may be a possible direct measurement providing a radial acceleration and improving the motion estimation.

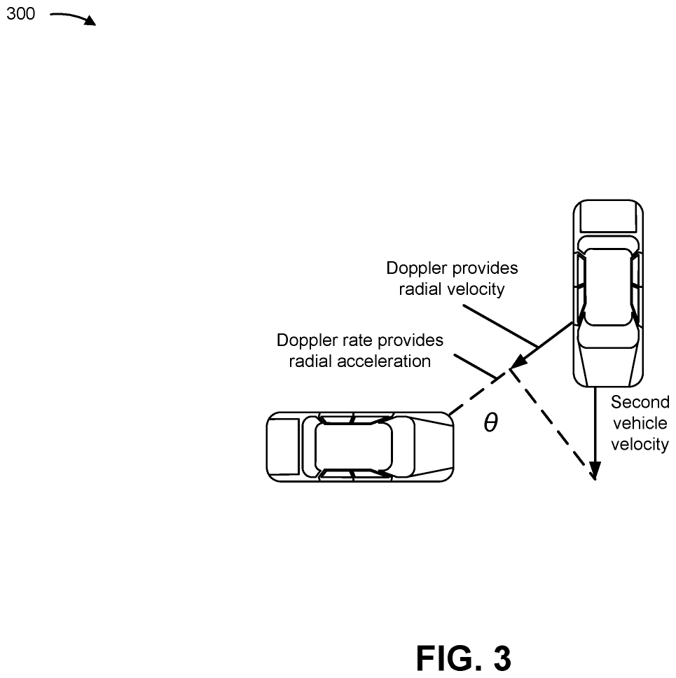

FIG. 3 is a diagram illustrating an example 300 of radial measurements, in accordance with the present disclosure.

As shown in FIG. 3, a first vehicle may be moving in relation to a second vehicle. The second vehicle may be moving at a certain velocity. The first vehicle may include a sensor, such as a radar sensor and/or a LIDAR sensor, to capture radial measurements. The first vehicle may use the sensor to measure an azimuth angle θ. A Doppler shift may provide a radial velocity. The radial velocity (\dot{r}) may be represented by

$$\dot{r} = \frac{c}{{f}_{0}} \cdot {f}_{doppler} ,$$

where c is the speed of light, f₀ is the sensor operating frequency, and f_{doppler} is the measured Doppler frequency. A Doppler rate may provide a radial acceleration. The radial acceleration (\ddot{r}) may be represented by

$$\ddot{r} = \frac{c}{{f}_{0}} \cdot \frac{d {f}_{doppler}}{dt} .$$

$$Further , for {f}_{0} = 77 GHz radar , \{ \begin{matrix}{f}_{doppler} = 256 Hz per [ m . {s}^{- 1} ] \\ \frac{{df}_{doppler}}{dt} = 256 Hz per [ m . {s}^{- 2} ]\end{matrix} , and for {λ}_{0} =$$

$$1550 nm coherent LIDAR , \{ \begin{matrix}{f}_{doppler} = 666.1 {0}^{3} Hz per [ m . {s}^{- 1} ] \\ \frac{{df}_{doppler}}{dt} = 66 \; 6.1 {0}^{3} Hz per [ m . {s}^{- 2} ]\end{matrix} ,$$

where λ₀ is an optical wavelength.

As indicated above, FIG. 3 is provided as an example. Other examples may differ from what is described with regard to FIG. 3.

A constant acceleration target state equation discrete model may be defined. Target dynamics may be defined by a state vector s=[x vₓ aₓ y v_{y} a_{y}]^{T}, where x indicates a distance in an x direction of a target, vₓ indicates a velocity in the x direction of the target, aₓ indicates an acceleration in the x direction of the target, y indicates a distance in a y direction of the target, v_{y} indicates a velocity in the y direction of the target, and a_{y} indicates an acceleration in the y direction of the target. A target model may assume that the acceleration is constant during a time interval Δt. The derivation of the acceleration (also commonly called jerk) may be a process noise represented by a random vector w, where

$$w = [ \begin{matrix}{w}_{x} \\ {w}_{y}\end{matrix} ]$$

is a Gaussian noise of zero mean and a covariance matrix

$$Cov ( {w}_{k} ) = Q = [ \begin{matrix}{σ}_{{\dot{a}}_{x}}^{2} & 0 \\ 0 & {σ}_{{\dot{a}}_{y}}^{2}\end{matrix} ] .$$

A discrete-time controlled process (uniform Δt time interval) may be expressed by a linear equation.

A sensor, such as a radar sensor or a coherent LIDAR sensor, may measure a radial range rₖ, an azimuth θₖ, and a relative radial velocity \dot{r}ₖ, where k is a time instance. The sensor may measure the radial range by a time-of-flight measurement (at the instant k*Δt). The sensor may measure the azimuth and elevation angles by an angular of arrival algorithm (at the instant k*Δt). The sensor may measure the relative radial velocity by a Doppler measurement (at the instant k*Δt).

An extended Kalman filter implementation may rely on the linearization of trigonometric functions, and may lack an angular rate, which may introduce residual errors and may cause a violation of Kalman error statistics. As a result, most extended Kalman filter implementations may be ad hoc, and the relationship between a measurement inaccuracy and a covariance matrix of an extended Kalman filter may be broken.

State-of-the-art measurement models (or measurement equations) may be associated with a relatively high degree of nonlinearity. For example, the following may be associated with non-linearities:

$${z}_{k} = [ \begin{matrix}{r}_{k} \cdot cos ( {θ}_{k} ) \\ {r}_{k} \cdot sin ( {θ}_{k} ) \\ {\dot{r}}_{k}\end{matrix} ] = [ \begin{matrix}{x}_{k} \\ {y}_{k} \\ \frac{1}{2} \cdot \frac{{x}_{k} \cdot {v}_{{x}_{k}} + {y}_{k} \cdot {v}_{{y}_{k}}}{\sqrt{{x}_{k}^{2} + {y}_{k}^{2}}}\end{matrix} ] or {z}_{k} = [ \begin{matrix}{r}_{k} \\ {θ}_{k} \\ {\dot{r}}_{k}\end{matrix} ] = [ \begin{matrix}\sqrt{{x}_{k}^{2} + {y}_{k}^{2}} \\ tan ( \frac{{x}_{k}}{{y}_{k}} ) \\ \frac{1}{2} \cdot \frac{{x}_{k} \cdot {v}_{{x}_{k}} + {v}_{{y}_{k}}}{\sqrt{{x}_{k}^{2} + {y}_{k}^{2}}}\end{matrix} ] .$$

Such state-of-the-art measurement models may be associated with a Taylor linearization with residual terms propagating error, a poor assumption regarding Gaussian zero mean error statistics, and/or a lost relationship between sensor measurements and a covariance matrix. Such state-of-the-art measurement models may produce residual errors, which may reduce an accuracy of estimates.

In various aspects of techniques and apparatuses described herein, a computing device may determine, via one or more sensors associated with the computing device, sensor measurements associated with a target. The computing device may be associated with a vehicle. The target may be associated with another vehicle. The sensor measurements may include a relative radial acceleration. The relative radial acceleration may be based at least in part on a Doppler chirp rate at a time instance. The computing device may determine a measurement model (e.g., a measurement vector) based at least in part on the sensor measurements associated with the target including the relative radial acceleration. The computing device may provide the measurement model to a second order Kalman filter. The computing device may determine, based at least in part on the second order Kalman filter, a state estimate of the target. The state estimate of the target may be a filtered estimation of a state vector. The computing device may provide a command based at least in part on the state estimate of the target. For example, the command may be associated with accelerating the vehicle, braking the vehicle, and/or turning the vehicle.

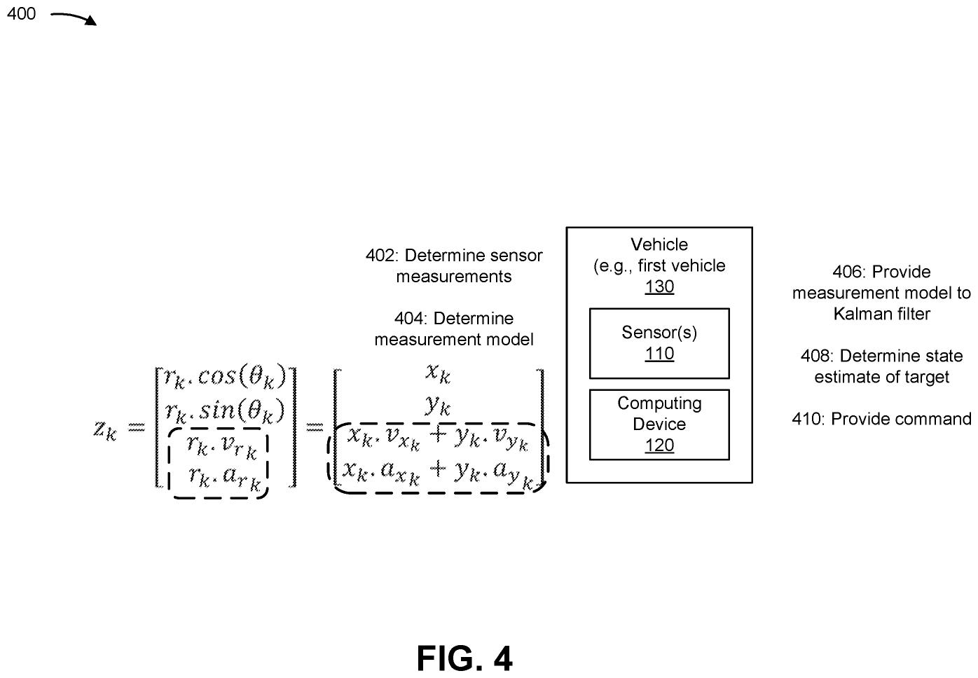

FIG. 4 is a diagram illustrating an example 400 associated with a state estimation of a target using sensor measurements, in accordance with the present disclosure.

As shown by reference number 402, a computing device may determine, via one or more sensors associated with the computing device, sensor measurements associated with a target. The one or more sensors may include a radar sensor and/or a LIDAR sensor. The computing device may be associated with a first vehicle (e.g., first vehicle 130). The target may be associated with a second vehicle (e.g., second vehicle 140). The sensor measurements may include a relative radial acceleration aᵣ(k), which may be based at least in part on a Doppler chirp rate at a time instance. The sensor measurements may further include a radial range rₖ that is based at least in part on a time-of-flight measurement at the time instance, an azimuth θₖ (and possibly an elevation angle) that is based at least in part on a digital beamforming at the time instance, and a relative radial velocity vᵣ(k) that is based at least in part on a Doppler measurement at the time instance. The sensor measurements may be measured directly and independently by the one or more sensors.

As shown by reference number 404, the computing device may determine a measurement model based at least in part on the sensor measurements associated with the target including the relative radial acceleration aᵣ(k). The measurement model may include a plurality of measurement vectors, and the plurality of measurement vectors may include:

$${e}^{- \frac{{σ}_{{θ}_{k}^{2}}}{2}} \cdot {r}_{k} \cdot cos ( {θ}_{k} ) , {e}^{- \frac{{σ}_{{θ}_{k}^{2}}}{2}} \cdot {r}_{k} \cdot sin ( {θ}_{k} ) ,$$

rₖ·vᵣ_{ₖ}, and rₖ·aᵣ_{ₖ}, where

$${e}^{- \frac{{σ}_{{θ}_{k}^{2}}}{2}} \cdot {r}_{k} \cdot cos ( {θ}_{k} ) , and {e}^{- \frac{{σ}_{{θ}_{k}^{2}}}{2}} \cdot {r}_{k} \cdot sin ( {θ}_{k} ) ,$$

may be associated with debiased measurements. The measurement vectors may be non-conventional measurement vectors that are based on an instantaneous Doppler chirp rate, which may improve an accuracy of an acceleration state estimation.

As shown by reference number 406, the computing device may provide the measurement model to a second order Kalman filter. The second order Kalman filter may be implemented with the non-conventional measurement vectors using the instantaneous Doppler chirp rate. In other words, the computing device may use the second order Kalman filter with the relative radial acceleration aᵣ(k) measurement.

As shown by reference number 408, the computing device may determine, based at least in part on the second order Kalman filter, a state estimate of the target. The second order Kalman filter may provide a filtered estimation of a state vector. The state estimate of the target may be the acceleration state estimation of the target. The state estimate of the target may be represented by s=[x vₓ aₓ y v_{y} a_{y}]^{T}, wherein x indicates a distance in an x direction of the target, vₓ indicates a relative velocity in the x direction of the target, aₓ indicates a relative acceleration in the x direction of the target, y indicates a relative distance in a y direction of the target, v_{y} indicates a relative velocity in the y direction of the target, and a_{y} indicates a relative acceleration in the y direction of the target. The state estimate of the target, as determined based at least in part on the second order Kalman filter, may be based at least in part on: xₖ, yₖ, xₖ·vₓ_{ₖ}+yₖ·v_{y}_{ₖ}, and xₖ·aₓ_{ₖ}+yₖ·a_{y}_{ₖ} in relation to the respective modified sensor measurements:

$${e}^{- \frac{{σ}_{{θ}_{k}^{2}}}{2}} \cdot {r}_{k} \cdot cos ( {θ}_{k} ) ; {e}^{- \frac{{σ}_{{θ}_{k}^{2}}}{2}} \cdot {r}_{k} \cdot sin ( {θ}_{k} ) ;$$

rₖ·vᵣ_{ₖ}, and rₖ·aᵣ_{ₖ}, where k indicates the time instance. The computing device may determine the state estimate of the target by excluding a linearization of trigonometric functions and avoiding non-linearities associated with the linearization of trigonometric functions.

As shown by reference number 410, the computing device may provide a command based at least in part on the state estimate of the target. The command may be associated with accelerating the first vehicle, braking the first vehicle, and/or turning the first vehicle. For example, depending on the acceleration state estimation associated with the second vehicle, the computing device may provide a command to maneuver the first vehicle, such that the first vehicle avoids a collision with the second vehicle.

As indicated above, FIG. 4 is provided as an example. Other examples may differ from what is described with regard to FIG. 4.

A constant acceleration target state equation discrete model may be defined. Target dynamics may be defined by a state vector s=[x vₓ aₓ y v_{y} a_{y}]^{T}, where x indicates a distance in an x direction of a target, vₓ indicates a velocity in the x direction of the target, aₓ indicates an acceleration in the x direction of the target, y indicates a distance in a y direction of the target, v_{y} indicates a velocity in the y direction of the target, and a_{y} indicates an acceleration in the y direction of the target. A target model may assume that the acceleration is constant during a time interval Δt.

A sensor, such as a radar sensor or a coherent LIDAR sensor, may directly and independently measure a radial range rₖ, an azimuth θₖ, a relative radial velocity vᵣ(k), and a relative radial acceleration aᵣ(k). The sensor may measure the radial range by a time-of-flight measurement (at the instant k*Δt). The sensor may measure the azimuth by digital beamforming (at the instant k*Δt). The sensor may measure the relative radial velocity by a Doppler measurement (at the instant k*Δt). The sensor may measure the relative radial acceleration by a Doppler chirp rate (at the instant k*Δt). The radial acceleration may not always be available and may be considered optional. The Doppler chirp rate may be measured with a coherent optical 1550 nanometer (nm) LIDAR sensor or a 77 GHz radar sensor. However, the Doppler chirp rate may also be measured with a 77 GHz radar when an acquisition time is increased beyond 100 ms.

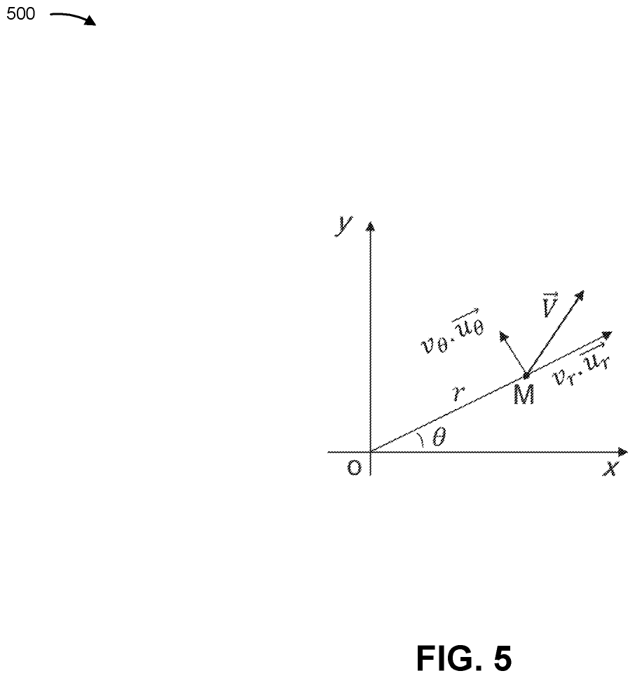

FIG. 5 is a diagram illustrating an example associated with a radial acceleration vector, in accordance with the present disclosure.

As shown in FIG. 5, a radial velocity vector (Cartesian and polar coordinates) may be defined according to: \vec{V}=\vec{vₓ}+\vec{v_{y}}=vᵣ·\vec{uᵣ}+v_{θ}·\vec{u_{θ}} e=\dot{r}·\vec{uᵣ}+r\dot{θ}·\vec{u_{θ}}, where the measured radial velocity corresponds to vᵣ=\dot{r}. A change from polar coordinates to Cartesian coordinates may result in vᵣ=cos(θ)·vₓ+sin(θ)·v_{y}, and multiplying both sides by r leads to r·vᵣ=(r·cos(θ))·vₓ+(r·sin(θ))·v_{y}, which becomes (by definition of x and y) r·vᵣ=x·vₓ+y·v_{y}.

As indicated above, FIG. 5 is provided as an example. Other examples may differ from what is described with regard to FIG. 5.

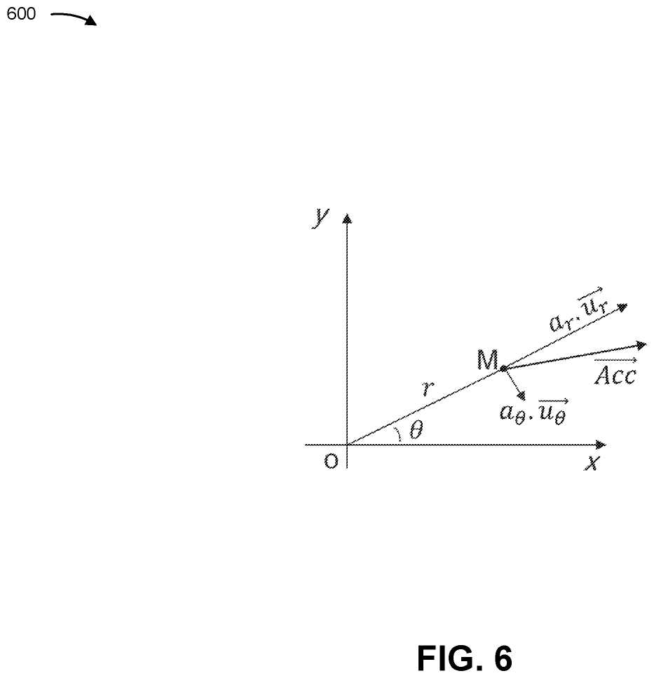

FIG. 6 is a diagram illustrating an example 600 associated with a radial velocity vector, in accordance with the present disclosure.

As shown in FIG. 6, a radial acceleration vector may be defined according to: \vec{Acc}=\vec{aₓ}+\vec{a_{y}}=aᵣ·\vec{uᵣ}+a_{θ}·\vec{u_{θ}}=(\ddot{r}−r·\dot{θ}²)·\vec{uᵣ}+(r·\ddot{θ}+2\dot{r}·\dot{θ})·\vec{u_{θ}}, where the measured radial acceleration corresponds to aᵣ=\ddot{r}−r·\dot{θ}². A change from polar coordinates to Cartesian coordinates may result in aᵣ=cos(θ)·aₓ+sin(θ)·a_{y}, and multiplying both sides by r leads to r·aᵣ=(r·cos(θ))·aₓ+(r·sin(θ))·a_{y}, which becomes r·aᵣ=x·aₓ+y·a_{y}.

As indicated above, FIG. 6 is provided as an example. Other examples may differ from what is described with regard to FIG. 6.

In some aspects, a radial velocity vector, which may be represented by r·vᵣ=x·vₓ+y·v_{y}, and a radial acceleration vector, which may be represented by r·aᵣ=x·aₓ+y·a_{y}, may take advantage of a bilinear relation. A measurement model (zₖ) may rely on the choice of modified measurement vectors in accordance with:

$${z}_{k} = [ \begin{matrix}{r}_{k} \cdot cos ( {θ}_{k} ) \\ {r}_{k} \cdot sin ( {θ}_{k} ) \\ {r}_{k} \cdot {v}_{{r}_{k}} \\ {r}_{k} \cdot {a}_{{r}_{k}}\end{matrix} ] = [ \begin{matrix}{x}_{k} \\ {y}_{k} \\ {x}_{k} \cdot {v}_{{x}_{k}} + {y}_{k} \cdot {v}_{{y}_{k}} \\ {x}_{k} \cdot {a}_{{x}_{k}} + {y}_{k} \cdot {a}_{{y}_{k}}\end{matrix} ] ,$$

where the aᵣ measurement is available.

In some aspects, a measurement model (zₖ) may take advantage of aᵣ and the relation between the measurement and the state vector being bilinear with independent variables. The measurement model (zₖ) may provide a closed and relatively simple form with a second order Kalman filter, and may conserve the Gaussian properties as required by the second order Kalman filter.

In some aspects, a second order measurement equation with an aᵣ acceleration measurement may be defined. For example, a nonlinear function of a measurement model (zₖ) including the acceleration term aᵣ may be defined in accordance with:

$${z}_{k} = [ \begin{matrix}{r}_{k} \cdot cos ( {θ}_{k} ) \\ {r}_{k} \cdot sin ( {θ}_{k} ) \\ {r}_{k} \cdot {v}_{{r}_{k}} \\ {r}_{k} \cdot {a}_{{r}_{k}}\end{matrix} ] = h ( {s}_{k} ) = [ \begin{matrix}{x}_{k} \\ {y}_{k} \\ {x}_{k} \cdot {v}_{{x}_{k}} + {y}_{k} \cdot {v}_{{y}_{k}} \\ {x}_{k} \cdot {a}_{{x}_{k}} + {y}_{k} \cdot {a}_{{y}_{k}}\end{matrix} ] ,$$

with s=[x vₓ aₓ y v_{y} a_{y}]^{T}. The nonlinearity may be a second order polynomial, which may mean that a second order Taylor development provides an exact form. A second order Kalman filter may rely on the Taylor development in accordance with: h(s+Δs)=h(s)+H(s)^{T}·Δs+½Σⱼ₌₁⁴e^{j}·Δs^{T}·H^{j}·Δs, where e¹=[1 0 0 0]^{T}, e²=[0 1 0 0]^{T}, e³=[0 0 1 0]^{T}, and e⁴=[0 0 0 1]^{T}, and where H is the Jacobian matrix (4×6) and H^{j} are the 4 Hessian matrixes (6×6) of the j^{th} component of h(s).

$$Further , ∇ h = H = [ \begin{matrix}1 & 0 & 0 & 0 & 0 & 0 \\ 0 & 0 & 0 & 1 & 0 & 0 \\ {v}_{x} & x & 0 & {v}_{y} & y & 0 \\ {a}_{x} & 0 & x & {a}_{y} & 0 & y\end{matrix} ] , and {H}^{1} = 0 ; {H}^{2} = 0 ; {H}^{3} = [ \begin{matrix}0 & 1 & 0 & 0 & 0 & 0 \\ 1 & 0 & 0 & 0 & 0 & 0 \\ 0 & 0 & 0 & 0 & 0 & 0 \\ 0 & 0 & 0 & 0 & 1 & 0 \\ 0 & 0 & 0 & 1 & 0 & 0 \\ 0 & 0 & 0 & 0 & 0 & 0\end{matrix} ] ; {H}^{4} = [ \begin{matrix}0 & 0 & 1 & 0 & 0 & 0 \\ 0 & 0 & 0 & 0 & 0 & 0 \\ 1 & 0 & 0 & 0 & 0 & 0 \\ 0 & 0 & 0 & 0 & 0 & 1 \\ 0 & 0 & 0 & 0 & 0 & 0 \\ 0 & 0 & 0 & 1 & 0 & 0\end{matrix} ] ,$$

such that the Hessian matrixes are constant. The measurement equation may be exact, and the residual of the Taylor formation may be null.

In some aspects, a second order Kalman filter may be defined with an aᵣ acceleration measurement. A Kalman filter formulation may be extended to the second order in accordance with

$$\{ \begin{matrix}{s}_{k + 1} = A \cdot {s}_{k} + W \cdot {w}_{k} \\ {z}_{k} = h ( {s}_{k} ) + {ε}_{k}\end{matrix} ,$$

where Cov(wₖ)=Qₖ and Cov(εₖ)=Rₖ. A process noise w and measurement noise E may be assumed to be white noise zero mean. The second order Kalman filter may estimate the state s from the measurements z by minimizing the covariance of the estimation error in accordance with Pₖ=E((sₖ−ŝₖ)^{T}·(sₖ−ŝₖ)). A time update may be conventional since a radar target state model may be linear, which may be in accordance with ŝ_{k|k-1}=A·ŝₖ₋₁ and \hat{P}_{k|k-1}=A·\hat{P}ₖ₋₁·A^{T}+W·Qₖ₋₁W^{T}. A measurement update with a second order measurement model may be represented by ŝ_{k|k}=ŝ_{k|k-1}+Kₖ·(zₖ−h(ŝ_{k|k-1})−Πₖ), where Πₖ=½·Σⱼ₌₁⁴e^{j}·tr(Hₖ^{j}·\hat{P}_{k|k-1}), and the Kalman gain Kₖ is in accordance with Kₖ=\hat{P}_{k|k-1}·Hₖ^{T}·(Hₖ·\hat{P}_{k|k-1}·Hₖ^{T}+R+Γₖ)⁻¹.

Further, Γₖ=½·Σᵢ₌₁⁴Σⱼ₌₁⁴eⁱe^{j}^{^{T}}·tr(Hₖⁱ·\hat{P}_{k|k-1}·Hₖ^{j}·\hat{P}_{k|k-1}), and an error covariance update may be in accordance with \hat{P}ₖ=(I−Kₖ·Hₖ)·\hat{P}_{k|k-1}. Further, a loop upon the next measurement update back to the time update may be performed.

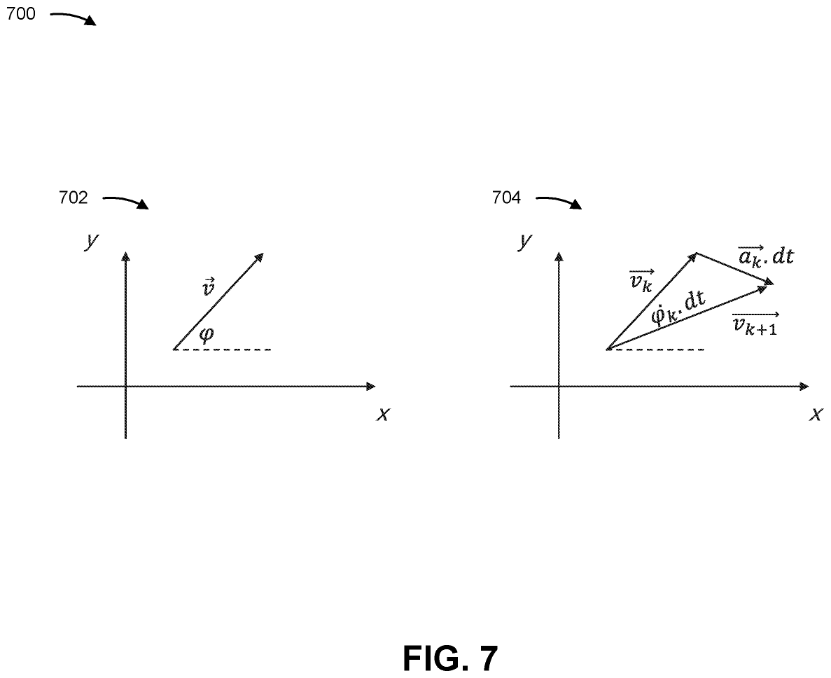

FIG. 7 is a diagram illustrating an example 700 of a yaw angle and yaw rate estimation, in accordance with the present disclosure.

As shown by reference number 702, a yaw angle (φ) may be derived in accordance with:

$$\{ \begin{matrix}{v}_{x} = ‖ \vec{v} ‖ \cdot cos ( φ ) = V \cdot cos ( φ ) \\ {v}_{y} = ‖ \vec{v} ‖ \cdot sin ( φ ) = V \cdot sin ( φ ) \\ {a}_{x} = \frac{d {v}_{x}}{dt} = \dot{V} \cdot cos ( φ ) - V \cdot \dot{φ} \cdot sin ( φ ) \\ {a}_{y} = \frac{d {v}_{y}}{dt} = \dot{V} \cdot sin ( φ ) + V \cdot \dot{φ} \cdot cos ( φ )\end{matrix} .$$

As shown by reference number 704, a yaw rate (\dot{φ}) may be derived, in part, by eliminating \dot{V} by substitution, which may result in a_{y}·cos(φ)−aₓ·sin(φ)=V·\dot{φ}. Eliminating φ by substitution may yield \dot{φ}, such that

$$\dot{φ} = \frac{{a}_{y} \cdot {v}_{x} - {a}_{x} \cdot {v}_{y}}{{V}^{2}} .$$

As indicated above, FIG. 7 is provided as an example. Other examples may differ from what is described with regard to FIG. 7.

In some aspects, for a second order Kalman filter, a measurement vector debiasing and a measurement covariance matrix may be defined. With respect to debiasing the measurement vector, sensor measurement noise (“error”) may be independent, Gaussian, and zero mean. The variance (σ) of the measurement may be reported by the sensor and estimated based at least in part on a signal-to-noise ratio (SNR) and system parameters. Sensor measurement noise may be defined for a range, a relative velocity, an azimuth, and a relative acceleration, respectively, in accordance with:

$${σ}_{r} = \frac{c}{2 \cdot B \cdot \sqrt{2 \cdot \frac{S}{N}}} ;$$

$${σ}_{\dot{r}} = \frac{c \cdot B \cdot λ}{2 \cdot \sqrt{2 \cdot \frac{S}{N}}} ;$$

$${σ}_{θ} = \frac{{θ}_{- 3 d B}}{\sqrt{2 \cdot \frac{S}{N}}} ,$$

where B is bandwidth, λ is the wavelength, θ_{-3 dB} is the −3 dB beamwidth, and S/N is the SNR. The variance of the relative acceleration σ_{\ddot{r}} may depend on the applied technique. The measurement covariance matrix may be directly related to the sensor measurement variances.

In some aspects, the second order Kalman filter may expect zero mean error. When considering the noisy measurement (rₘ; \dot{r}ₘ; \ddot{r}ₘ; θₘ) resulting from the (εᵣ; ε_{\dot{r}}; ε_{\dot{r}}; ε_{θ}) zero mean independent noises superimposed to the true values (r; \dot{r}; \ddot{r}; θ), the converted measurement vector in the second order Kalman filter may be unbiased when E(zₘ)=z.

In some aspects, with respect to debiasing the measurement vector, measurement noises may be zero mean. However, the converted measurements x=r·cos(θ) and y=r·sin(θ) are no longer zero mean since E(cos(θ))≠0. Consider

$$\{ \begin{matrix}{r}_{m} = r + {ε}_{r} \\ {θ}_{m} = θ + {ε}_{θ}\end{matrix} ,$$

where (εᵣ; ε_{θ}) are the zero mean independent noise and (rₘ; θₘ) represents the noisy measurements, and (r; θ) represents the true value. After simplification:

$$\begin{matrix}E ( [ \begin{matrix}{r}_{m} \cdot cos ( {θ}_{m} ) \\ {r}_{m} \cdot sin ( {θ}_{m} )\end{matrix} ] ) = E ( [ \text{} \begin{matrix}( r + {ε}_{r} ) \cdot cos ( θ + {ε}_{θ} ) \\ ( r + {ε}_{r} ) \cdot sin ( θ + {ε}_{θ} )\end{matrix} ] ) = \\ [ \text{} \begin{matrix}E ( cos ( {ε}_{θ} ) ) \cdot r \cdot cos ( θ ) \\ E ( cos ( {ε}_{θ} ) ) \cdot r \cdot sin ( θ )\end{matrix} ] = [ \text{} \begin{matrix}{e}^{\frac{{{σ}_{θ}}^{2}}{2}} \cdot r \cdot cos ( θ ) \\ {e}^{\frac{{{σ}_{θ}}^{2}}{2}} \cdot r \cdot sin ( θ )\end{matrix} ] \neq [ \text{} \begin{matrix}r \cdot cos ( θ ) \\ r \cdot sin ( θ )\end{matrix} ] ( biased ) .\end{matrix}$$

A modified and unbiased measurement vector may be defined as:

$$[ \begin{matrix}{e}^{- \frac{{σ}_{{θ}^{2}}}{2}} \cdot {r}_{m} \cdot cos ( {θ}_{m} ) \\ {e}^{- \frac{{σ}_{{θ}^{2}}}{2}} \cdot {r}_{m} \cdot sin ( {θ}_{m} ) \\ {r}_{m} \cdot {v}_{{r}_{m}} \\ {r}_{m} \cdot {a}_{{r}_{m}}\end{matrix} ] .$$

### Indeed:

$$E ( [ \begin{matrix}{e}^{- \frac{{{σ}_{θ}}^{2}}{2}} \cdot {r}_{m} \cdot cos ( {θ}_{m} ) \\ {e}^{- \frac{{{σ}_{θ}}^{2}}{2}} \cdot {r}_{m} \cdot sin ( {θ}_{m} )\end{matrix} ] ) = [ \text{} \begin{matrix}{e}^{- \frac{{{σ}_{θ}}^{2}}{2}} \cdot {e}^{- \frac{{{σ}_{θ}}^{2}}{2}} \cdot r \cdot cos ( θ ) \\ {e}^{- \frac{{{σ}_{θ}}^{2}}{2}} \cdot {e}^{- \frac{{{σ}_{θ}}^{2}}{2}} \cdot r \cdot sin ( θ )\end{matrix} ] = [ \text{} \begin{matrix}r \cdot cos ( θ ) \\ r \cdot sin ( θ )\end{matrix} ] ( hence , unbiased ) .$$

### Further,

$$E ( [ \begin{matrix}{r}_{m} \cdot {v}_{{r}_{m}} \\ {r}_{m} \cdot {a}_{{r}_{m}}\end{matrix} ] ) = [ \begin{matrix}E ( ( r + {ε}_{r} ) \cdot ( {v}_{r} + {ε}_{\dot{r}} ) ) \\ E ( ( r + {ε}_{r} ) \cdot ( {a}_{r} + {ε}_{{a}_{r}} ) )\end{matrix} ] = [ \begin{matrix}r \cdot {v}_{r} \\ r \cdot {a}_{r}\end{matrix} ]$$

after simplification (hence, unbiased).

In some aspects, substituting the measurement vector zₘ by the modified unbiased vector zₘ^{u} may yield E(zₘ^{u})=z^{u}. The expectation of the measurement may be equal to the true value without a bias. Thus, the unbiased modified measurement vector (zₘ^{u}) may be in accordance with:

$${z}_{m}^{u} = [ \begin{matrix}{e}^{- \frac{{σ}_{{θ}_{m}^{2}}}{2}} \cdot {r}_{m} \cdot cos ( {θ}_{m} ) \\ {e}^{- \frac{{σ}_{{θ}_{m}^{2}}}{2}} \cdot {r}_{m} \cdot sin ( {θ}_{m} ) \\ {r}_{m} \cdot {v}_{{r}_{m}} \\ {r}_{m} \cdot {a}_{{r}_{m}}\end{matrix} ] .$$

An updated system may be defined in accordance with:

$$\{ \begin{matrix}{s}_{k + 1} = A \cdot {s}_{k} + W \cdot {w}_{k} \\ {z}_{{m}_{k}}^{u} = h ( {s}_{k} ) + {ε}_{k}\end{matrix} .$$

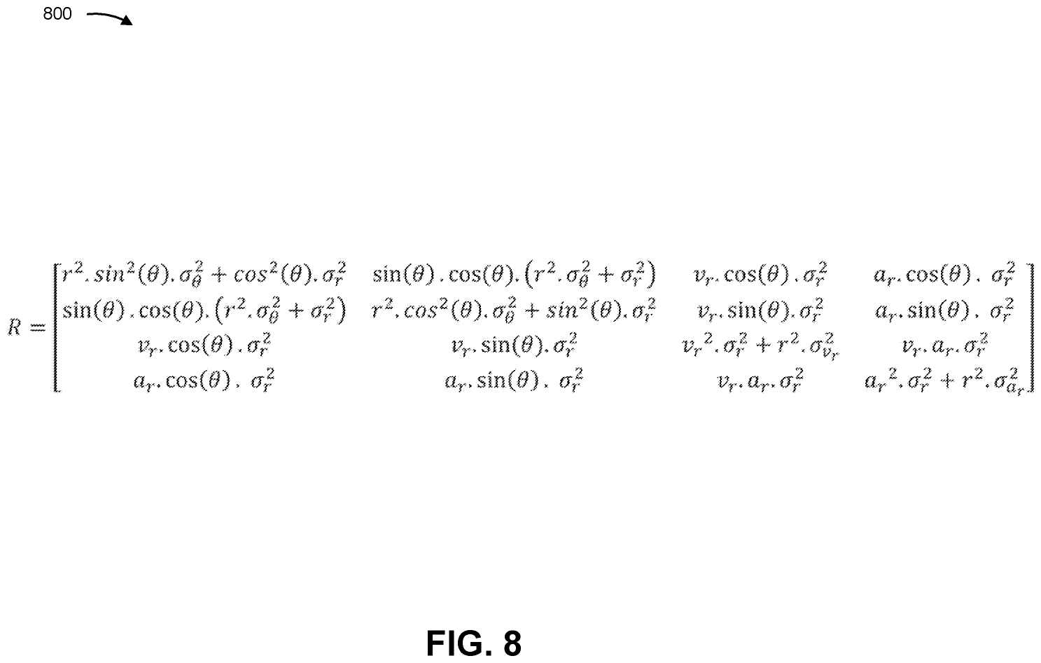

FIG. 8 is a diagram illustrating an example 800 of a calculation of a measurement covariance matrix, in accordance with the present disclosure.

As shown in FIG. 8, a measurement covariance matrix (R) may be defined and calculated explicitly. The measurement covariance matrix R, as shown in FIG. 8, may be based at least in part on:

$$R = [ \begin{matrix}{R}_{xx} & {R}_{xy} & {R}_{x ( {rv}_{r} )} & {R}_{x ( {ra}_{r} )} \\ {R}_{xy} & {R}_{yy} & {R}_{y ( {rv}_{r} )} & {R}_{y ( {ra}_{r} )} \\ {R}_{x ( {rv}_{r} )} & {R}_{y ( {rv}_{r} )} & {R}_{( {rv}_{r} ) ( {rv}_{r} )} & {R}_{{rv}_{r} ( {ra}_{r} )} \\ {R}_{x ( {ra}_{r} )} & {R}_{y ( {ra}_{r} )} & {R}_{( {rv}_{r} ) ( {ra}_{r} )} & {R}_{( {ra}_{r} ) ( {ra}_{r} )}\end{matrix} ] .$$

In some aspects, when considering that the noise of the sensor (εᵣ; εᵥ_{ᵣ}; εₐ_{ᵣ}; ε_{θ}) is independent and zero mean, each component of the measurement covariance matrix may be developed in relation to the sensor measurement accuracies. For example, E(εᵣ)=0; E(εᵣ²)=σᵣ²; E(ε_{θ})=0; E(ε_{θ}²)=σ_{θ}²; E(εᵥ_{ᵣ})=0; E(εᵥ_{ᵣ}²)=σᵥ_{ᵣ}²; E(εₐ_{ᵣ})=0; E(εₐ_{ᵣ}²)=σₐ_{ᵣ}². Each error variance may be dependent on the SNR of the measurement and reported by the sensor.

As indicated above, FIG. 8 is provided as an example. Other examples may differ from what is described with regard to FIG. 8.

In some aspects, a classic formulation of a measurement vector may suffer from several disadvantages. The classic formulation may be associated with a Taylor linearization with residual terms propagating error. The classic formulation may be associated with a poor assumption regarding the Gaussian zero mean error statistics. The classic formulation may be associated with a lost relationship between the sensor measurements and the covariance matrix.

In some aspects, a new formulation of a measurement vector may be associated with several advantages. The new formulation may leverage the direct sensor measurements (e.g., the direct sensor measurements and nothing else). The new formulation may provide a direct relationship between the sensor error variance (depending on SNR) and the covariance matrix of the second order Kalman filter. The new formulation may be associated with a second order linearization that is explicit in an exact form with a null residual, which may result in a more accurate estimate. The new formulation may be associated with measurement errors that are Gaussian zero mean, as required by the Kalman optimization. The new formulation may be well-suited to radial measurements by sensors, such as radar sensors or LIDAR sensors. A measurement model may scale to combined radar and LIDAR measurements. The new formulation may take advantage of the direct measurement of target relative acceleration by Doppler chirp rate (which may be especially relevant for coherent LIDAR). In other words, the target relative acceleration may be directly measured based at least in part on the Doppler chirp rate. The new formulation may eliminate the need for cascading filters, which may lower latency and allow for a simpler calibration.

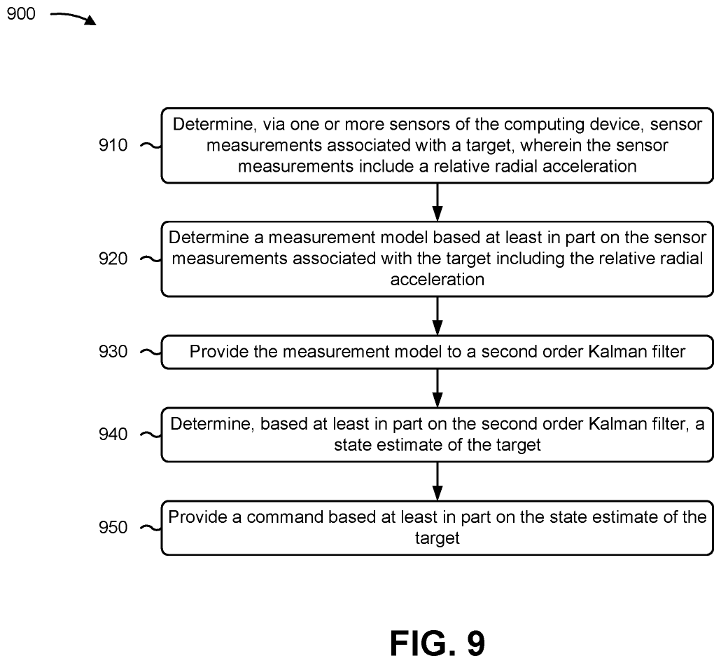

FIG. 9 is a flowchart of an example process 900 associated with state estimation of a target using sensor measurements. In some implementations, one or more process blocks of FIG. 9 are performed by a computing device (e.g., computing device 120). In some implementations, one or more process blocks of FIG. 9 are performed by another device or a group of devices separate from or including the computing device, such as a sensor (e.g., sensor 110), and/or a vehicle (e.g., first vehicle 130). Additionally, or alternatively, one or more process blocks of FIG. 9 may be performed by one or more components of device 200, such as processor 210, memory 215, storage component 220, input component 225, output component 230, communication interface 235, and/or sensor 240.

As shown in FIG. 9, process 900 may include determining, via one or more sensors of the computing device, sensor measurements associated with a target, wherein the sensor measurements include a relative radial acceleration aᵣ(k) (block 910). For example, the computing device may determine, via one or more sensors of the computing device, sensor measurements associated with a target, wherein the sensor measurements include a relative radial acceleration aᵣ(k), as described above.

As further shown in FIG. 9, process 900 may include determining a measurement model based at least in part on the sensor measurements associated with the target including the relative radial acceleration aᵣ(k) (block 920). For example, the computing device may determine a measurement model based at least in part on the sensor measurements associated with the target including the relative radial acceleration aᵣ(k), as described above.

As further shown in FIG. 9, process 900 may include providing the measurement model to a second order Kalman filter (block 930). For example, the computing device may provide the measurement model to a second order Kalman filter, as described above.

As further shown in FIG. 9, process 900 may include determining, based at least in part on the second order Kalman filter, a state estimate of the target (block 940). For example, the computing device may determine, based at least in part on the second order Kalman filter, a state estimate of the target, as described above.

As further shown in FIG. 9, process 900 may include providing a command based at least in part on the state estimate of the target (block 950). For example, the computing device may provide a command based at least in part on the state estimate of the target, as described above.

Process 900 may include additional implementations, such as any single implementation or any combination of implementations described below and/or in connection with one or more other processes described elsewhere herein.

In a first implementation, the sensor measurements further include: a radial range rₖ that is based at least in part on a time-of-flight measurement at the time instance, an azimuth θₖ that is based at least in part on a digital beamforming at the time instance, and a relative radial velocity vᵣ(k) that is based at least in part on a Doppler measurement at the time instance.

In a second implementation, alone or in combination with the first implementation, the measurement model includes a plurality of modified measurement vectors, and the plurality of modified measurement vectors includes:

$${e}^{- \frac{{σ}_{{θ}_{k}^{2}}}{2}} \cdot {r}_{k} \cdot cos ( {θ}_{k} ) ,$$

$${e}^{- \frac{{σ}_{{θ}_{k}^{2}}}{2}} \cdot {r}_{k} \cdot sin ( {θ}_{k} ) ,$$

rₖ·vᵣ_{ₖ}, and rₖ·aᵣ_{ₖ}, where σ is a variance symbol.

In a third implementation, alone or in combination with one or more of the first and second implementations, the state estimate of the target is represented by s=[x vₓ aₓ y v_{y} a_{y}]^{T}, wherein x indicates a relative distance in an x direction of the target, vₓ indicates a relative velocity in the x direction of the target, aₓ indicates a relative acceleration in the x direction of the target, y indicates a relative distance in a y direction of the target, v_{y} indicates a relative velocity in the y direction of the target, and a_{y} indicates a relative acceleration in the y direction of the target.

In a fourth implementation, alone or in combination with one or more of the first through third implementations, the state estimate of the target, as determined based at least in part on the second order Kalman filter, is based at least in part on: xₖ, yₖ, (xₖ·vₓ_{ₖ}+yₖ·v_{y}_{ₖ}), and (xₖ·aₓ_{ₖ}+yₖ·a_{y}_{ₖ}) in relation to modified sensor measurements, where k indicates the time instance.

In a fifth implementation, alone or in combination with one or more of the first through fourth implementations, the sensor measurements are measured directly and independently by the one or more sensors of the computing device.

In a sixth implementation, alone or in combination with one or more of the first through fifth implementations, a variance associated with the relative radial acceleration aᵣ(k) is based at least in part on an SNR and system parameters, and a measurement covariance matrix is based at least in part on the variance associated with the relative radial acceleration aᵣ(k).

In a seventh implementation, alone or in combination with one or more of the first through sixth implementations, determining the state estimate of the target excludes a linearization of trigonometric functions and avoids non-linearities associated with the linearization of trigonometric functions.

In an eighth implementation, alone or in combination with one or more of the first through seventh implementations, the one or more sensors include one or more of a radar sensor or a LIDAR sensor.

In a ninth implementation, alone or in combination with one or more of the first through eighth implementations, the computing device is associated with a vehicle, and the target is associated with another vehicle.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

The following provides an overview of some Aspects of the present disclosure.

Aspect 1: An apparatus, comprising: one or more sensors; a memory; and one or more processors, coupled to the memory, configured to: determine, via one or more sensors of the computing device, sensor measurements associated with a target, wherein the sensor measurements include a relative radial acceleration aᵣ(k); determine a measurement model based at least in part on the sensor measurements associated with the target including the relative radial acceleration aᵣ(k); provide the measurement model to a second order Kalman filter; determine, based at least in part on the second order Kalman filter, a state estimate of the target; and provide a command based at least in part on the state estimate of the target.

Aspect 2: The apparatus of Aspect 1, wherein the sensor measurements further include: a radial range rₖ that is based at least in part on a time-of-flight measurement at the time instance, an azimuth θₖ that is based at least in part on a digital beamforming at the time instance, and a relative radial velocity vᵣ(k) that is based at least in part on a Doppler measurement at the time instance.

Aspect 3: The apparatus of Aspect 2, wherein the measurement model includes a plurality of modified measurement vectors, and wherein the plurality of modified measurement vectors includes:

$${e}^{- \frac{{σ}_{{θ}_{k}^{2}}}{2}} \cdot {r}_{k} \cdot cos ( {θ}_{k} ) ,$$

$${e}^{- \frac{{σ}_{{θ}_{k}^{2}}}{2}} \cdot {r}_{k} \cdot sin ( {θ}_{k} ) ,$$

rₖ·vᵣ_{ₖ}, and rₖ·aᵣ_{ₖ}, where σ is a variance symbol.

Aspect 4: The apparatus of any of Aspects 1-3, wherein the state estimate of the target is represented by s=[x vₓ aₓ y v_{y} a_{y}]^{T}, wherein x indicates a relative distance in an x direction of the target, vₓ indicates a relative velocity in the x direction of the target, aₓ indicates a relative acceleration in the x direction of the target, y indicates a relative distance in a y direction of the target, v_{y} indicates a relative velocity in the y direction of the target, and a_{y} indicates a relative acceleration in the y direction of the target.

Aspect 5: The apparatus of Aspect 4, wherein the state estimate of the target, as determined based at least in part on the second order Kalman filter, is based at least in part on: xₖ, yₖ, (xₖ·vₓ_{ₖ}+yₖ·v_{y}_{ₖ}), and (xₖ·aₓ_{ₖ}+yₖ·a_{y}_{ₖ}) in relation to modified sensor measurements, where k indicates the time instance.

Aspect 6: The apparatus of any of Aspects 1-5, wherein the sensor measurements are measured directly and independently by the one or more sensors of the device.

Aspect 7: The apparatus of any of Aspects 1-6, wherein a variance associated with the relative radial acceleration aᵣ(k) is based at least in part on a signal-to-noise ratio (SNR) and system parameters, and wherein a measurement covariance matrix is based at least in part on the variance associated with the relative radial acceleration aᵣ(k).

Aspect 8: The apparatus of any of Aspects 1-7, wherein the one or more processors are configured to determine the state estimate of the target by excluding a linearization of trigonometric functions and avoids non-linearities associated with the linearization of trigonometric functions.

Aspect 9: The apparatus of any of Aspects 1-8, wherein the one or more sensors include one or more of: a radar sensor or a light detection and ranging (LIDAR) sensor.

Aspect 10: The apparatus of any of Aspects 1-9, wherein the apparatus is associated with a vehicle, and wherein the target is associated with another vehicle.

Aspect 11: A method configured to perform one or more operations recited in one or more of Aspects 1-10.

Aspect 12: A system configured to perform one or more operations recited in one or more of Aspects 1-10.

Aspect 13: An apparatus comprising means for performing one or more operations recited in one or more of Aspects 1-10.

Aspect 14: A non-transitory computer-readable medium storing a set of instructions, the set of instructions comprising one or more instructions that, when executed by a device, cause the device to perform one or more operations recited in one or more of Aspects 1-10.

Aspect 15: A computer program product comprising instructions or code for executing one or more operations recited in one or more of Aspects 1-10.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus, comprising:
one or more sensors;
a memory; and
one or more processors, coupled to the memory, configured to:
determine, via the one or more sensors, sensor measurements associated with a target, wherein the sensor measurements include a relative radial acceleration aᵣ(k)
determine a measurement model based at least in part on the sensor measurements associated with the target including the relative radial acceleration aᵣ(k);
provide the measurement model to a second order Kalman filter;
determine, based at least in part on the second order Kalman filter, a state estimate of the target; and
provide a command based at least in part on the state estimate of the target.

2. The apparatus of claim 1, wherein the sensor measurements further include:
a radial range rₖ that is based at least in part on a time-of-flight measurement at the time instance,
an azimuth θₖ that is based at least in part on a digital beamforming at the time instance, and
a relative radial velocity vᵣ(k) that is based at least in part on a Doppler measurement at the time instance.

3. The apparatus of claim 2, wherein the measurement model includes a plurality of modified measurement vectors, and wherein the plurality of modified measurement vectors includes:
$${e}^{- \frac{{σ}_{{θ}_{k}^{2}}}{2}} \cdot {r}_{k} \cdot cos ( {θ}_{k} ) ,$$
$${e}^{- \frac{{σ}_{{θ}_{k}^{2}}}{2}} \cdot {r}_{k} \cdot sin ( {θ}_{k} ) ,$$
rₖ·vᵣ_{ₖ}, and rₖ·aᵣ_{ₖ}, where σ is a variance symbol.

4. The apparatus of claim 1, wherein the state estimate of the target is represented by s=[x vₓ aₓ y v_{y} a_{y}]^{T}, wherein x indicates a relative distance in an x direction of the target, vₓ indicates a relative velocity in the x direction of the target, aₓ indicates a relative acceleration in the x direction of the target, y indicates a relative distance in a y direction of the target, v_{y} indicates a relative velocity in the y direction of the target, and a_{y} indicates a relative acceleration in the y direction of the target.

5. The apparatus of claim 4, wherein the state estimate of the target, as determined based at least in part on the second order Kalman filter, is based at least in part on: xₖ, yₖ, (xₖ·vₓ_{ₖ}+yₖ·v_{y}_{ₖ}), and (xₖ·aₓ_{ₖ}+yₖ·a_{y}_{ₖ}) in relation to modified sensor measurements, where k indicates the time instance.

6. The apparatus of claim 1, wherein the sensor measurements are measured directly and independently by the one or more sensors.

7. The apparatus of claim 1, wherein a variance associated with the relative radial acceleration aᵣ(k) is based at least in part on a signal-to-noise ratio (SNR) and system parameters, and wherein a measurement covariance matrix is based at least in part on the variance associated with the relative radial acceleration aᵣ(k).

8. The apparatus of claim 1, wherein the one or more processors are configured to determine the state estimate of the target by excluding a linearization of trigonometric functions and avoiding non-linearities associated with the linearization of trigonometric functions.

9. The apparatus of claim 1, wherein the one or more sensors include one or more of: a radar sensor or a light detection and ranging (LIDAR) sensor.

10. The apparatus of claim 1, wherein the apparatus is associated with a vehicle, and wherein the target is associated with another vehicle.

11. A method performed by a computing device, comprising:
determining, via one or more sensors of the computing device, sensor measurements associated with a target, wherein the sensor measurements include a relative radial acceleration aᵣ(k);
determining a measurement model based at least in part on the sensor measurements associated with the target including the relative radial acceleration aᵣ(k);
providing the measurement model to a second order Kalman filter;
determining, based at least in part on the second order Kalman filter, a state estimate of the target; and
providing a command based at least in part on the state estimate of the target.

12. The method of claim 11, wherein the sensor measurements further include:
a radial range rₖ that is based at least in part on a time-of-flight measurement at the time instance,
an azimuth θₖ that is based at least in part on a digital beamforming at the time instance, and
a relative radial velocity vᵣ(k) that is based at least in part on a Doppler measurement at the time instance.

13. The method of claim 12, wherein the measurement model includes a plurality of modified measurement vectors, and wherein the plurality of modified measurement vectors includes:
$${e}^{- \frac{{σ}_{{θ}_{k}^{2}}}{2}} \cdot {r}_{k} \cdot cos ( {θ}_{k} ) ,$$
$${e}^{- \frac{{σ}_{{θ}_{k}^{2}}}{2}} \cdot {r}_{k} \cdot sin ( {θ}_{k} ) ,$$
rₖ·vᵣ_{ₖ}, and rₖ·aᵣ_{ₖ}, where σ is a variance symbol.

14. The method of claim 11, wherein the state estimate of the target is represented by s=[x vₓ aₓ y v_{y} a_{y}]^{T}, wherein x indicates a distance in an x direction of the target, vₓ indicates a velocity in the x direction of the target, aₓ indicates an acceleration in the x direction of the target, y indicates a distance in a y direction of the target, v_{y} indicates a velocity in the y direction of the target, and a_{y} indicates an acceleration in the y direction of the target.

15. The method of claim 14, wherein the state estimate of the target, as determined based at least in part on the second order Kalman filter, is based at least in part on: xₖ, yₖ, (xₖ·vₓ_{ₖ}+yₖ·v_{y}_{ₖ}), and (xₖ·aₓ_{ₖ}+yₖ·a_{y}_{ₖ}) in relation to modified sensor measurements, where k indicates the time instance.

16. The method of claim 11, wherein the sensor measurements are measured directly and independently by the one or more sensors of the computing device.

17. The method of claim 11, wherein a variance associated with the relative radial acceleration aᵣ(k) is based at least in part on a signal-to-noise ratio (SNR) and system parameters, and wherein a measurement covariance matrix is based at least in part on the variance associated with the relative radial acceleration aᵣ(k).

18. The method of claim 11, wherein determining the state estimate of the target excludes a linearization of trigonometric functions and avoids high order non-linearities associated with the linearization of trigonometric functions.

19. The method of claim 11, wherein the one or more sensors include one or more of: a radar sensor or a light detection and ranging (LIDAR) sensor.

20. The method of claim 11, wherein the computing device is associated with a vehicle, and wherein the target is associated with another vehicle.

21. A non-transitory computer-readable medium storing a set of instructions, the set of instructions comprising:
one or more instructions that, when executed by one or more processors of a computing device, cause the computing device to:
determine, via one or more sensors of the computing device, sensor measurements associated with a target, wherein the sensor measurements include a relative radial acceleration aᵣ(k);
determine a measurement model based at least in part on the sensor measurements associated with the target including the relative radial acceleration aᵣ(k);
provide the measurement model to a second order Kalman filter;
determine, based at least in part on the second order Kalman filter, a state estimate of the target; and
provide a command based at least in part on the state estimate of the target.

22. The non-transitory computer-readable medium of claim 21, wherein the sensor measurements further include:
a radial range rₖ that is based at least in part on a time-of-flight measurement at the time instance,
an azimuth θₖ that is based at least in part on a digital beamforming at the time instance, and
a relative radial velocity vᵣ(k) that is based at least in part on a Doppler measurement at the time instance.

23. The non-transitory computer-readable medium of claim 22, wherein the measurement model includes a plurality of modified measurement vectors, and wherein the plurality of modified measurement vectors includes:
$${e}^{- \frac{{σ}_{{θ}_{k}^{2}}}{2}} \cdot {r}_{k} \cdot cos ( {θ}_{k} ) ,$$
$${e}^{- \frac{{σ}_{{θ}_{k}^{2}}}{2}} \cdot {r}_{k} \cdot sin ( {θ}_{k} ) ,$$
rₖ·vᵣ_{ₖ}, and rₖ·aᵣ_{ₖ}, where σ is a variance symbol.

24. The non-transitory computer-readable medium of claim 21, wherein the state estimate of the target is represented by s=[x vₓ aₓ y v_{y} a_{y}]^{T}, wherein x indicates a relative distance in an x direction of the target, vₓ indicates a relative velocity in the x direction of the target, aₓ indicates a relative acceleration in the x direction of the target, y indicates a relative distance in a y direction of the target, v_{y} indicates a relative velocity in the y direction of the target, and a_{y} indicates a relative acceleration in the y direction of the target.

25. The non-transitory computer-readable medium of claim 24, wherein the state estimate of the target, as determined based at least in part on the second order Kalman filter, is based at least in part on: xₖ, yₖ, (xₖ·vₓ_{ₖ}+yₖ·v_{y}_{ₖ}), and (xₖ·aₓ_{ₖ}+yₖ·a_{y}_{ₖ}) in relation to modified sensor measurements, where k indicates the time instance.

26. An apparatus, comprising:
means for determining sensor measurements associated with a target, wherein the sensor measurements include a relative radial acceleration aᵣ(k);
means for determining a measurement model based at least in part on the sensor measurements associated with the target including the relative radial acceleration aᵣ(k);
means for providing the measurement model to a second order Kalman filter;
means for determining, based at least in part on the second order Kalman filter, a state estimate of the target; and
means for providing a command based at least in part on the state estimate of the target.

27. The apparatus of claim 26, wherein the sensor measurements further include:
a radial range rₖ that is based at least in part on a time-of-flight measurement at the time instance,
an azimuth θₖ that is based at least in part on a digital beamforming at the time instance, and
a relative radial velocity vᵣ(k) that is based at least in part on a Doppler measurement at the time instance.

28. The apparatus of claim 27, wherein the measurement model includes a plurality of modified measurement vectors, and wherein the plurality of modified measurement vectors includes:
$${e}^{- \frac{{σ}_{{θ}_{k}^{2}}}{2}} \cdot {r}_{k} \cdot cos ( {θ}_{k} ) ,$$
$${e}^{- \frac{{σ}_{{θ}_{k}^{2}}}{2}} \cdot {r}_{k} \cdot sin ( {θ}_{k} ) ,$$
rₖ·vᵣ_{ₖ}, and rₖ·aᵣ_{ₖ}, where σ is a variance symbol.

29. The apparatus of claim 26, wherein the state estimate of the target is represented by s=[x vₓ aₓ y v_{y} a_{y}]^{T}, wherein x indicates a relative distance in an x direction of the target, vₓ indicates a relative velocity in the x direction of the target, aₓ indicates a relative acceleration in the x direction of the target, y indicates a relative distance in a y direction of the target, v_{y} indicates a relative velocity in the y direction of the target, and a_{y} indicates a relative acceleration in the y direction of the target.

30. The apparatus of claim 29, wherein the state estimate of the target, as determined based at least in part on the second order Kalman filter, is based at least in part on: xₖ, yₖ, (xₖ·vₓ_{ₖ}+yₖ·v_{y}_{ₖ}), and (xₖ·aₓ_{ₖ}+yₖ·a_{y}_{ₖ}) in relation to modified sensor measurements, where k indicates the time instance.
